(19) United States
(12) Patent Application Publication
(10) Pub. No.: US 2026/0278111 A1
(43) Pub. Date: Sep. 17, 2026

(54) Detection and Remediation of Security Vulnerabilities in Artificial Intelligence-Generated Programming Language Source Code

(71) Applicant: Oracle International Corporation, Redwood Shores, CA (US)

(72) Inventors: Hitesh Laxmichand Patel, Jersey City, NJ (US); Olaitan Philip Olaleye, Short Hills, NJ (US); Paul Li, Fremont, CA (US)

(73) Assignee: Oracle International Corporation, Redwood Shores, CA (US)

(21) Appl. No.: 19/079,928

(22) Filed: Mar. 14, 2025

(51) Int. Cl. G06F 21/57; G06F 21/54; G06F 21/56

(52) U.S. Cl. CPC G06F 21/577; G06F 21/54; G06F 21/563

(57) ABSTRACT

Security vulnerabilities in programming language source code generated by Language Models (LMs) are addressed through a two-part approach combining static analysis with LM-based remediation. In an implementation, a “base” LM is used for initial code generation, followed by a static analysis tool that identifies security vulnerabilities and a smaller “guardrail” LM (1-7 billion parameters) trained for generating security fixes. Unlike traditional approaches that regenerate entire code blocks, the implementation uses targeted fixing through special tokens that mark vulnerable code sections, allowing precise modifications while maintaining code context and structure. The implementation encompasses an iterative validation process to ensure fixes resolve identified vulnerabilities and can handle complex scenarios, including multi-line vulnerabilities and cross-file dependencies. This approach provides a practical solution for organizations to safely incorporate AI-generated code into their development pipeline, addressing the substantial percentage of base LM-suggested code encompassing security vulnerabilities.

### TECHNICAL FIELD

This disclosure relates generally to artificial intelligence (AI) systems. More particularly, this disclosure relates to using AI systems to generate programming language source code.

### BACKGROUND

Language Models (LMs) have become increasingly prevalent in programing language source code generation (or just “code generation” for short) with studies showing that approximately 25% of code generated at major technology companies is now AI-driven. While these models demonstrate remarkable capabilities in generating functional code and assisting with debugging tasks, they introduce significant security concerns that threaten the integrity of software systems. Studies have revealed that up to 40% of LM-suggested code includes security vulnerabilities, and developers are 10% more likely to accept problematic AI-generated code compared to their own code.

The security risk stems from fundamental limitations in how these models learn to generate code. LMs are trained on vast repositories of public code and documentation, which often include outdated, insecure, or poorly designed code patterns. Without explicit understanding of security standards and best practices, these models inadvertently learn and reproduce vulnerable patterns. This can manifest in various ways, such as generating login functions without proper encryption, implementing weak password storage mechanisms, or introducing SQL injection vulnerabilities.

The challenge is particularly acute when dealing with large or complex codebases involving multiple dependencies. In these scenarios, LMs may lack the full context necessary to suggest secure modifications, potentially introducing vulnerabilities that impact the broader system. Even more concerning is that these security flaws may not be immediately apparent, for the generated code often appears functional and passes basic testing despite harboring hidden vulnerabilities.

The situation is further complicated by the impracticality of traditional solutions. Fine-tuning LMs on secure code examples could theoretically address these issues, but creating comprehensive datasets of expert-reviewed, secure code examples for the various popular programming languages and vulnerability types would be both prohibitively expensive and logistically challenging. As organizations increasingly adopt AI-driven code generation tools, the urgency grows to find an effective solution to prevent the proliferation of security vulnerabilities in AI-generated code. A technical challenge lies in ensuring the security of AI-generated code without sacrificing the productivity benefits these tools provide.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for generating secure programming code using two LMs, analyzing security vulnerabilities, and applying targeted remediation according to one or more embodiments;

FIG. 2 illustrates a system for analyzing source code using static analysis to identify security vulnerabilities and generate structured output for code annotation according to one or more embodiments;

FIG. 3 illustrates a system for training a guardrail LM using pairs of programming source code encompassing vulnerabilities and their corresponding remediated versions according to one or more embodiments;

FIG. 4 illustrates a system for dividing source code into sections, marking a vulnerable middle section with special tokens, and combining sections for security remediation according to one or more embodiments;

FIG. 5 illustrates a system for identifying and remediating security vulnerabilities spanning multiple files by collecting relevant source code files and providing them to a specialized LM according to one or more embodiments;

FIG. 6 illustrates a system for iteratively analyzing and remediating security vulnerabilities in programming code through repeated analysis, annotation, and model application according to one or more embodiments;

FIG. 7 illustrates a system for training a specialized LM to remediate predetermined prioritized security vulnerabilities based on security standards and organizational requirements according to one or more embodiments;

FIG. 8 illustrates a system for analyzing security vulnerabilities in source code and handling external dependency vulnerabilities through manual remediation rather than LM processing according to one or more embodiments;

FIG. 9 illustrates a system for comparing a general-purpose LM having a large number of parameters with a specialized security LM having fewer parameters according to one or more embodiments;

FIG. 10 illustrates an example transformer model architecture that may be used in the implementation of a LM according to one or embodiments; and

FIG. 11 is a block diagram that illustrates an example computer system upon which one or more embodiments are implemented.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to one or more other embodiments. In some embodiments, well-known structures and devices are shown in the figures in block diagram form to avoid unnecessarily obscuring the embodiment.
1. GENERAL OVERVIEW
2. DETECTION AND REMEDIATION OF SECURITY VULNERABILITIES IN ARTIFICIAL INTELLIGENCE-GENERATED PROGRAMMING LANGUAGE SOURCE CODE
   2.1 STATIC ANALYSIS PIPELINE FOR SECURITY VULNERABILITY DETECTION
   2.2 GUARDRAIL MODEL TRAINING USING VULNERABILITY-REMEDIATION PAIRS
   2.3 CODE SECTIONING AND TOKEN-BASED VULNERABILITY MARKING
   2.4 MULTI-FILE VULNERABILITY REMEDIATION SYSTEM
   2.5 ITERATIVE SECURITY ANALYSIS AND REMEDIATION LOOP
   2.6 PRIORITIZED SECURITY VULNERABILITY TRAINING SYSTEM
   2.7 EXTERNAL DEPENDENCY VULNERABILITY HANDLING SYSTEM
   2.8 MODEL SIZE COMPARISON ARCHITECTURE
3. EXAMPLE EMBODIMENT
4. PRACTICAL APPLICATIONS; ADVANTAGES; IMPROVEMENTS
5. EXAMPLE LANGUAGE MODEL SYSTEMS
6. COMPUTER NETWORKS AND CLOUD NETWORKS
7. HARDWARE OVERVIEW
8. MISCELLANEOUS; EXTENSIONS

### 1. GENERAL OVERVIEW

One or more embodiments execute a security enhancement pipeline that applies a specialized LM, trained for code remediation, to code generated by another larger LM. In these embodiments, initial programming language source code is first obtained from output generated by a first LM. This initial code then undergoes security analysis to generate structured output that identifies potential vulnerabilities present in the code. After vulnerabilities are identified, the code is annotated to mark the specific locations and types of security issues found based on the structured output. The system submits the annotated code to a second LM that is smaller in size compared to the first LM and trained for security vulnerability remediation of code that has been annotated based on structured output. This second model generates updated code that addresses the identified security vulnerabilities while preserving the structure and functionality of the original code where possible. This approach allows for targeted security improvements without requiring complete regeneration of the code, combining the generative capabilities of a larger LM with the specialized security expertise of a smaller, focused model.

In some embodiments, a static analysis tool identifies vulnerable code portions and their vulnerability types, producing structured output that guides the annotation process. The second LM may be trained using pairs of vulnerable and corrected code versions, learning patterns for effective security remediation.

One or more embodiments employ a structured code division approach, separating code into prefix, middle (vulnerable), and suffix sections marked with special tokens to guide precise fixes. When vulnerabilities span multiple files, relevant files are identified and provided as context to the second LM.

One or more embodiments implement an iterative improvement process, repeatedly analyzing and fixing code until no vulnerabilities remain. The second LM may be specifically trained to address a predetermined set of prioritized security vulnerabilities based on security standards or organizational requirements.

One or more embodiments distinguish between code-level vulnerabilities and those stemming from external dependencies, flagging the latter for manual remediation rather than automated fixing. The size difference between the models can be substantial with the second LM potentially having, for example, 1% to 10% of the parameters of the first, general-purpose model while maintaining specialized security expertise.

One or more embodiments described in this Specification and/or recited in the claims may not be included in the General Overview section.

### 2.0 DETECTION AND REMEDIATION OF SECURITY VULNERABILITIES IN ARTIFICIAL INTELLIGENCE-GENERATED PROGRAMMING LANGUAGE SOURCE CODE

One or more embodiments will now be described with respect to the figures. In one or more embodiments, a system depicted in a figure may include more or fewer components than the components illustrated in the figure. The components illustrated in the figure may be local to or remote from each other. The components illustrated in the figure may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in Section 6, titled “Computer Networks and Cloud Networks.” In one or more embodiments, one or more operations performed by a system illustrated in a figure may be modified, rearranged, or omitted. Accordingly, the particular sequence of operations illustrated in a figure should not be construed as limiting the scope of one or more embodiments.

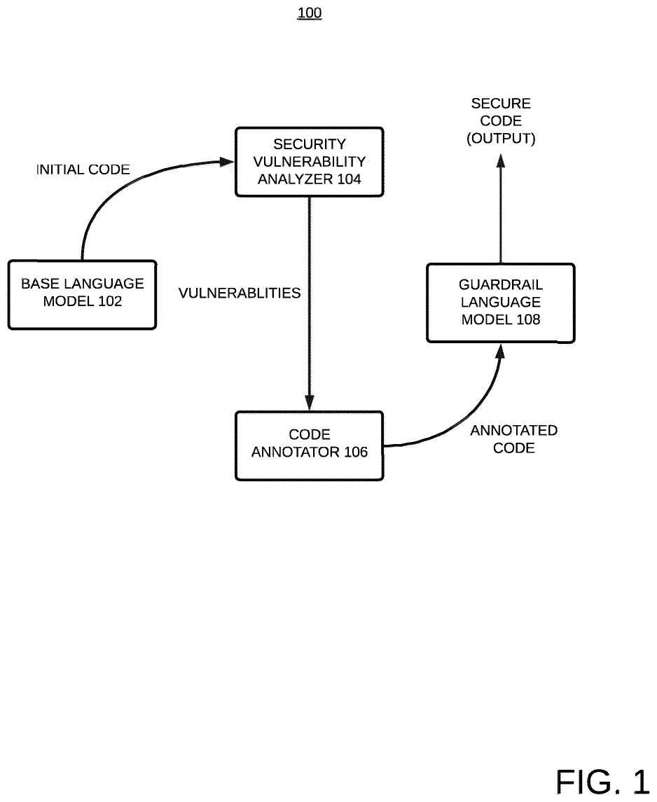

FIG. 1 illustrates a system 100 for generating secure programming code using two LMs, analyzing security vulnerabilities, and applying targeted remediation according to one or more embodiments.

One or more embodiments obtain initial programming language source code that is generated by a “base” LM 102. A “base” LM is a large-scale LM trained for general-purpose code generation tasks, including creating new code from natural language prompts and modifying existing code. A security analysis conducted by a security vulnerability analyzer 104 identifies one or more security vulnerabilities within the initial source code. A code annotator 106 then annotates the initial source code to indicate the locations and types of identified security vulnerabilities. These annotations create an annotated version of the programming language source code. A “guardrail” LM 108, smaller than the base LM and trained for security vulnerability remediation, processes the annotated source code. A “guardrail” LM is a LM trained on pairs of vulnerable and remediated code to identify and fix security vulnerabilities while maintaining code context and structure. The guardrail LM 108 generates updated programming language source code that addresses the identified security vulnerabilities while preserving at least some portions of the initial source code. The nature and smaller size of the guardrail LM 108 enables efficient and focused remediation of security issues without completely regenerating the entire codebase.

One or more embodiments obtain initial programming language source code from the base LM 102 in response to user prompts or requests. This base LM 102 represents a general-purpose code generation model that can create code, documentation, or unit tests based on user input. The base LM 102 typically has a larger architecture, including, for example, 70-100 billion or more parameters, and is trained on broad datasets that may include public code repositories and documentation. While this model excels at general code generation tasks, the base LM 102's training data may include outdated, insecure, or poorly designed code patterns that could lead to security vulnerabilities in the generated code. The initial code generation process marks the beginning of the security-focused pipeline where the generated code will subsequently undergo security analysis and remediation. Studies have shown that up to 40% of code suggested by such LMs may include security vulnerabilities.

One or more embodiments of the security vulnerability analyzer 104 analyze initial source code using a static analysis tool to identify security vulnerabilities in code generated by the base language mode 102. The static analysis tool scans the generated code using language-specific configurations and produces detailed vulnerability information in a structured format like JSON. This analysis identifies both the specific line numbers encompassing vulnerabilities and the type of security vulnerability present, such as those found in the Open Web Application Security Project (OWASP) Top 25/50 vulnerabilities list or organization-specific security priorities. The static analysis tool can detect vulnerabilities across multiple files when issues span different modules or have cross-file dependencies. When processing external dependency vulnerabilities, the static analysis tool flags security issues stemming from imported modules or package versions that may require manual version updates rather than code modifications. The analysis component operates deterministically by parsing code to extract key information about vulnerabilities without requiring a separate machine learning model. The analysis serves as a security guardrail, like content moderation systems, ensuring vulnerable code is identified before the vulnerable code reaches production environments. The tool's output provides context for the subsequent remediation steps, including precise location information and vulnerability classifications, that enable targeted fixes by the guardrail LM 108.

One or more embodiments of the code annotator 106 mark or label identified security vulnerabilities within the source code. One or more embodiments use special tokens to annotate the vulnerable code sections identified by a static analysis tool. These annotations serve as markers that help guide the guardrail LM 108 in generating targeted fixes.

One or more embodiments of the code annotator 106 implement this annotation process by inserting specialized tokens around vulnerable code segments. The code annotator 106 uses tokens like “FILL_PREFIX”, “FILL_HERE”, and “FILL_SUFFIX” to clearly demarcate the sections requiring security fixes. These annotations divide the code into three distinct sections: the code above the vulnerable lines (prefix), the vulnerable code itself (middle), and the code below the vulnerable lines (suffix).

One or more embodiments of the code annotator 106 create these annotations based on specific information from the static analysis tool, including the exact line numbers encompassing vulnerabilities and the type of security vulnerability present. The annotation process preserves the surrounding code structure while clearly marking where security fixes should be applied. This targeted approach allows the guardrail LM 108 to focus specifically on fixing the vulnerable code segments while maintaining the integrity of the rest of the codebase.

One or more embodiments of the code annotator 106 can handle multiple vulnerabilities in a single file by inserting multiple sets of annotation tokens around each identified vulnerable code segment. This annotation strategy enables the guardrail LM 108 to process and fix multiple security issues while preserving the overall code structure and context.

One or more embodiments apply the guardrail LM 108 to generate secure code fixes for identified vulnerabilities. The guardrail LM 108 processes the annotated code that includes special tokens (like <FILL-HERE>, <fim-prefix>, and <fim-suffix>) marking vulnerable code sections. This model focuses on security vulnerability remediation rather than general code generation. The model generates updated code that fixes the identified vulnerabilities while preserving the surrounding code structure and context.

One or more embodiments implement this guardrail LM 108 with 1-7 billion parameters, making the guardrail LM 108 significantly smaller than general-purpose models that may have 70-100 billion or more parameters. The model generates multiple candidate solutions for fixing the identified vulnerabilities using an infilling technique. These candidate solutions undergo validation through the static analysis tool to verify that the vulnerabilities have been properly addressed. The model continues this iterative process until either finding a secure solution or exhausting all candidate fixes.

One or more embodiments train this guardrail LM 108 on pairs of vulnerable and fixed code from security vulnerability datasets, allowing the guardrail LM 108 to learn patterns for fixing different types of security issues while maintaining code structure integrity.

One or more embodiments provide a method for identifying and fixing security vulnerabilities in AI-generated code through a two-model pipeline approach. The method begins by obtaining source code that is initially generated by the base LM 102 in response to user prompts or requests.

One or more embodiments then analyze this initial code using static analysis techniques to identify potential security vulnerabilities. The static analysis examines the code structure and patterns to detect common security issues, such as SQL injection vulnerabilities, cross-site scripting risks, or improper encryption implementations.

One or more embodiments then annotate the identified vulnerable sections of code using special tokens. These annotations mark the specific locations of security vulnerabilities while preserving the surrounding code context. The annotations create a structured format that guides subsequent fix generation.

One or more embodiments then pass this annotated code to the guardrail LM 108 that specializes in security vulnerability remediation. The guardrail LM 108 processes the annotations and generates targeted fixes for the identified vulnerabilities. The guardrail LM 108 model maintains the original code structure while replacing the vulnerable portions with secure implementations.

One or more embodiments ensure efficiency by using a smaller, focused model for the fix generation step. Unlike the base LM 102 used for initial code generation, the guardrail LM 108 includes only 1-7 billion parameters and trains on security vulnerability patterns. This specialization allows the guardrail LM 108 to generate high-quality security fixes with lower computational overhead than larger models.

One or more embodiments account for cases where the security vulnerability analyzer 104 does not identify any security vulnerabilities in the code generated by the base LM 102. In such instances, the system bypasses the annotation and remediation steps, and the initial programming language source code proceeds directly to the output stage without modification. This direct path ensures computational efficiency by avoiding unnecessary processing when code already meets security standards. However, the system may still maintain a record of the security analysis results for audit purposes and to continuously improve the base LM 102's code generation capabilities. By tracking instances of secure code generation, the system can identify patterns that lead to secure outputs, potentially informing future refinements to the base LM 102 through targeted training or prompt engineering techniques. This approach maintains the integrity of the security pipeline while optimizing performance for already-secure code segments.

### 2.1 Static Analysis Pipeline for Security Vulnerability Detection

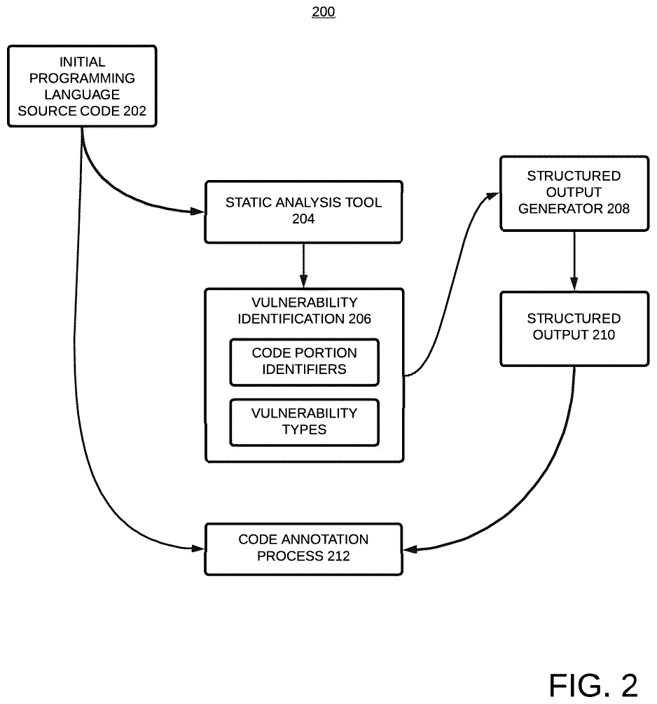

FIG. 2 illustrates a system 200 for analyzing source code using static analysis to identify security vulnerabilities and generate structured output for code annotation according to one or more embodiments. The system 200 represents an extension of the system 100 of FIG. 1. Unless the context clearly indicates otherwise, the system 200 may be used in conjunction with, or instead of, any other extension of system 100 of FIG. 1 disclosed herein with respect to the other figures.

One or more embodiments analyze initial programming language source code 202 using a static analysis tool 204 to identify portions of code, including security vulnerabilities. The static analysis tool 204 examines the code and determines both the specific code sections, including vulnerabilities and the corresponding types of vulnerabilities, are present. A structured output generator 208 generates a structured output 210. The structured output 210 includes identifiers pointing to the vulnerable code portions along with their associated vulnerability types. This structured output 210 then serves as the basis for a code annotation process 212 that annotates the initial source code 202. The annotations incorporate the vulnerability information from the structured output 210 to clearly mark and identify the security issues in the code. These annotations enable the guardrail LM to subsequently process the code 202 and generate updated source code that remedies the identified vulnerabilities while preserving other functional aspects of the original implementation.

One or more embodiments use initial programming language source code 202 as input that the base LM generates from user prompts. A static analysis tool analyzes this code to identify security vulnerabilities and their types, such as SQL injection, cross-site scripting (XSS), or hardcoded credentials. The static analysis tool outputs JSON that specifies vulnerable code locations with line numbers and vulnerability metadata. The system annotates the vulnerable code sections with special tokens (FILL_PREFIX, FILL_HERE, FILL_SUFFIX). The guardrail LM then uses this annotated code to generate targeted fixes while preserving the surrounding code structure and functionality.

One or more embodiments employ a static analysis tool 204 that scans code generated by the base LM to identify security vulnerabilities. The tool performs language-specific analysis to detect vulnerable patterns and outputs structured JSON data that includes vulnerability details, including line numbers and vulnerability types, like SQL injection or XSS. The static analysis tool 204 enables precise code annotation by placing special tokens around vulnerable segments while preserving context. The static analysis tool 204 systematically processes the entire codebase to identify both single-line and multi-line vulnerability patterns, generating standardized outputs that enable consistent vulnerability processing by the guardrail LM.

One or more embodiments employ a vulnerability identification component 206 that performs static analysis on code generated by the base LM. The vulnerability identification component 206 detects potential security issues using language-specific configurations and static analysis tools. The vulnerability identification component 206 outputs JSON-formatted data that includes vulnerability details, including line numbers, code segments, vulnerability types (like SQL injection or XSS), and contextual metadata. The vulnerability identification component 206 functions as a security guardrail and provides input for annotating vulnerable code sections that the guardrail LM will remediate.

One or more embodiments include a structured output generator 208 that processes static analysis results from programming source code into a standardized format that includes security vulnerability information. The generator extracts vulnerability locations, types (like CWE identifiers), line numbers, and contextual code information. The generator outputs this data in a standard format, like JSON, enabling consistent processing regardless of the original static analysis tool used. The structured output supports code annotation to mark security issues in the original source code.

One or more embodiments utilize a structured output 210 that includes security vulnerability information from static analysis in a standardized format like JSON. The output includes vulnerability types, affected line numbers, and contextual metadata needed for fixes. The static analysis tool processes code from a base LM using language-specific configurations. Special tokens mark vulnerable code segments that require fixing by a guardrail LM while preserving surrounding code structure.

One or more embodiments use static analysis tools to identify security vulnerabilities in code generated by the base LM and produce structured JSON output that includes vulnerability details, such as CWE identifiers, code locations, and contextual metadata. As part of a code annotation process 212, the code is divided into three sections-prefix, vulnerable code, and suffix—with special tokens (“FILL_PREFIX”, “FILL_HERE”, “FILL_SUFFIX”, respectively) inserted to mark vulnerable segments. For multiple vulnerabilities, multiple token sets are inserted. The standardized annotation format combines original code, vulnerability type, line numbers, and tokens to work with different static analysis tools. The guardrail LM uses the annotated code to generate targeted security fixes while preserving the surrounding code structure.

One or more embodiments analyze initial programming language source code 202 using a static analysis tool 204 to identify security vulnerabilities and generate structured information about those vulnerabilities. The static analysis tool 204 scans the code 202 using language-specific configurations and produces a structured output 210, such as JSON, that includes detailed vulnerability information. This information includes specific identifiers for the vulnerable code portions, such as line numbers or code segment ranges, along with the corresponding types of vulnerabilities detected (e.g., SQL injection, cross-site scripting, etc.).

One or more embodiments use this structured output 210 from the static analysis tool 204 to annotate (code annotation process 212) the original source code 202. The annotation process 212 adds special markers or tokens around the identified vulnerable code segments. These annotations serve as clear indicators showing exactly where security issues exist within the code. The structured nature of the static analysis output enables deterministic processing—the system can precisely locate and mark vulnerable code sections based on the provided identifiers.

One or more embodiments leverage the combination of static analysis and structured annotation to prepare the code for targeted fixing by the guardrail LM. Rather than requiring the guardrail model to scan the entire codebase for potential issues, the annotations directly guide the guardrail model to the specific locations that require security fixes. This focused approach helps the guardrail model generate more accurate fixes while preserving the surrounding code structure. The structured output 210's vulnerability type information also helps the guardrail model understand exactly what kind of security issue the guardrail model needs to address at each annotated location.

### 2.2 Guardrail Model Training Using Vulnerability-Remediation Pairs

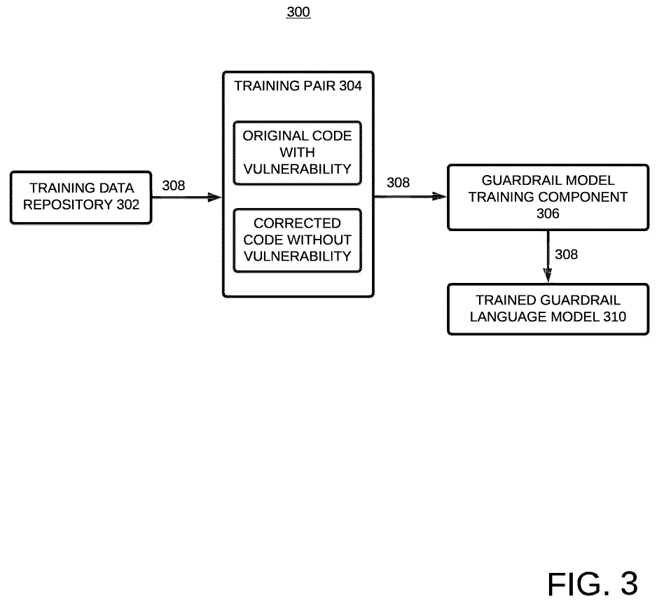

FIG. 3 illustrates a system 300 for training the guardrail LM using pairs of programming source code encompassing vulnerabilities and their corresponding remediated versions according to one or more embodiments. The system 300 represents an extension of the system 100 of FIG. 1. Unless the context clearly indicates otherwise, the system 300 may be used in conjunction with, or instead of, any other extension of system 100 of FIG. 1 disclosed herein with respect to the other figures.

One or more embodiments train the guardrail LM using pairs of programming language source code examples. Each training pair 304 in the training data includes two versions of code—an original version including a security vulnerability and a corrected version with that vulnerability fixed. This paired training approach enables the guardrail LM to learn patterns for identifying and remediating specific types of security issues. The model develops an understanding of how vulnerable code constructs should be transformed into secure implementations while preserving the original program functionality. By training on these before/after examples, the guardrail LM 310 becomes specialized in the targeted task of security vulnerability remediation. This specialized training allows the guardrail LM 310 to efficiently generate updated code that addresses identified vulnerabilities when applied to new annotated source code while maintaining a smaller model size compared to the base LM that generated the initial code.

One or more embodiments utilize a training data repository 302 that stores pairs of programming source code, comprising vulnerable and corrected versions, to train a guardrail LM for security vulnerability remediation. The repository 302 incorporates data from the Common Vulnerabilities and Exposures (CVE) database, National Vulnerability Database (NVD), and other security repositories, preprocessing code samples into input-output pairs. The repository 302 prioritizes examples addressing high-priority security concerns from the OWASP Top 25/50 vulnerabilities list. The training data includes contextual information about vulnerability types and locations, enabling accurate remediation pattern learning while preserving code structure integrity.

One or more embodiments organize training data into pairs of code examples using a training pair structure 304. Each pair 304 includes vulnerable source code and its corresponding fixed version. The training data comes from software repositories, the NVD, and CVE databases. A preprocessing pipeline converts these pairs into structured input-output format, with vulnerable code as input and fixed code as output. Special tokens, like <FILL-HERE>, mark vulnerable code sections during training. This structure enables the guardrail LM to learn vulnerability patterns and fixes while preserving code structure, developing security remediation expertise despite the guardrail LM's smaller size compared to general-purpose models.

One or more embodiments employ a guardrail model training component 306 to train the guardrail LM using pairs of vulnerable and fixed code samples from repositories, like the NVD and CVE databases. A preprocessing pipeline converts these pairs into structured input-output format, marking vulnerable sections with special tokens, such as <FILL-HERE>, <fim-prefix>, and <fim-suffix>. The focused training enables the guardrail LM to learn security vulnerability fix patterns while maintaining code structure, resulting in an efficient 1-7 billion parameter model specialized for security remediation.

One or more embodiments encompass a training process 308 in which paired code samples flow through training, where each pair includes vulnerable source code and its secure counterpart. The training teaches the model to identify security vulnerabilities and generate appropriate fixes while preserving code structure. This approach enables learning from real-world security remediation examples, helping the model develop expertise in fixing specific security issues while maintaining code context and integrity.

One or more embodiments employ a guardrail LM 310 trained on paired examples of vulnerable and fixed code to remediate security vulnerabilities. The model, including 2-7 billion parameters, processes code pairs where each pair includes the original vulnerable code and its fixed counterpart. This focused training enables vulnerability pattern recognition and appropriate fix generation while maintaining code structure. During execution, the model takes annotated code with marked vulnerable sections as input and produces targeted fixes while preserving non-vulnerable code portions.

One or more embodiments train a guardrail LM for security vulnerability remediation using carefully curated training data pairs. Each training pair comprises two versions of programming language source code. The first version includes a known security vulnerability, while the second version shows the corrected code with that vulnerability properly fixed. These training pairs come from software repositories where developers have identified and fixed security issues through code commits. For example, when a developer discovers SQL injection vulnerability in a database query and commits a fix, both the vulnerable query and its secure version become a training pair. The model learns patterns for fixing different types of security vulnerabilities by studying these before-and-after code examples. This targeted training approach helps the model avoid learning bad security practices that may exist in general code repositories. By focusing specifically on vulnerability remediation patterns, the model can effectively generate secure fixes while being much smaller than general-purpose code models. The training data can come from various sources, including the CVE database, the NVD database, and other security-focused code repositories that document both vulnerable code and corresponding fixes. This specialized training enables the model to understand the context of different vulnerability types and generate appropriate fixes while maintaining the overall code structure.

### 2.3 Code Sectioning and Token-Based Vulnerability Marking

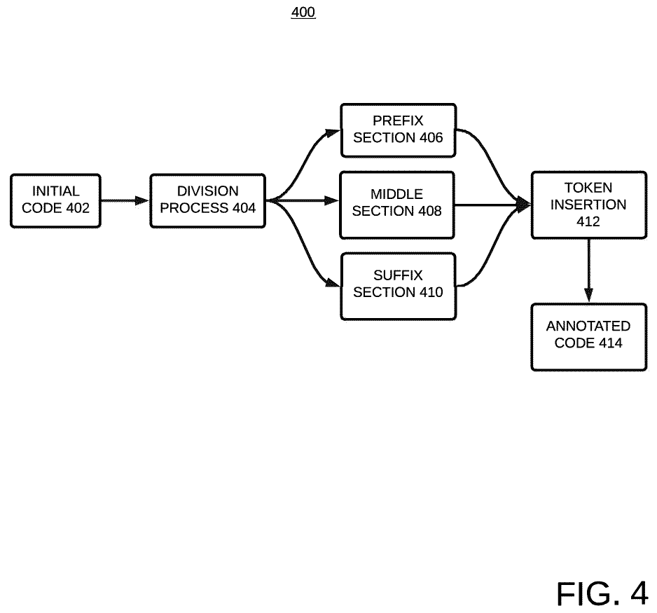

FIG. 4 illustrates a system 400 for dividing source code into sections, marking a vulnerable middle section with special tokens, and combining sections for security remediation according to one or more embodiments. The system 400 represents an extension of the system 100 of FIG. 1. Unless the context clearly indicates otherwise, the system 400 may be used in conjunction with, or instead of, any other extension of system 100 of FIG. 1 disclosed herein with respect to the other figures.

One or more embodiments process the initial programming language source code 402 by dividing (process 404) the initial programming language source code into three distinct sections based on the location of an identified security vulnerability. The first section, called the prefix section 406, includes the source code that appears before the security vulnerability. The second section, called the middle section 408, includes the security vulnerability itself. The third section, called the suffix section 410, includes the source code that appears after the security vulnerability. Special tokens are inserted (Operation 412) to clearly mark the boundaries of the middle section that includes the vulnerability. When applying the security-focused guardrail LM to generate updated code, the model processes these three sections along with the special tokens. The model uses the prefix section 406, the marked vulnerability section 408 with its special tokens, and the suffix section 410 to generate updated programming language source code that remedies the security vulnerability while preserving appropriate portions of the original code. This structured approach helps the smaller, security-specialized LM focus specifically on the vulnerable code section while maintaining the context provided by the surrounding code sections.

One or more embodiments process source code by starting with an initial code block 402 generated by the base LM in response to a user request. A division process 404 divides the code into three sections when detecting a security vulnerability: a prefix section above the vulnerable code, a middle section including the vulnerable code, and a suffix section below the vulnerable code. A token insertion process 412 inserts special tokens around the middle section to indicate where the guardrail LM should generate fixes while preserving the original code structure while only targeting vulnerable portions for modification.

One or more embodiments implement code segmentation by dividing (Operation 404) source code into three sections: a prefix section including code before a vulnerability, a middle section including the vulnerable code, and a suffix section including code after the vulnerability. Special tokens mark the section boundaries with tokens like “FILL_HERE” replacing or indicating the middle section. The guardrail LM then generates security fixes specifically for the marked middle section while preserving the prefix and suffix sections intact, ensuring proper integration of the fixes with the surrounding code context.

One or more embodiments create a prefix section block 406 that includes source code that appears before an identified security vulnerability. This prefix block provides context for the guardrail LM to understand code structure and dependencies when generating security fixes. The prefix section 406 remains unchanged during fix generation since the prefix section includes secure code. The system passes the prefix section 406, special tokens, and a suffix section to the guardrail LM to enable generation of contextually appropriate security fixes while preserving the surrounding code structure.

One or more embodiments process vulnerable code by dividing the vulnerable code into three sections: a prefix section 406 including code above the vulnerability, a middle section 408 including the vulnerable code segment, and a suffix section 410 including code below the vulnerability. The middle section 408 is replaced with special tokens like “FILL_HERE” during annotation to indicate where security fixes should be generated. The guardrail LM uses this structure to maintain full code context while focusing fix generation on the vulnerable portion, enabling precise targeting of security issues while preserving surrounding code.

One or more embodiments include a suffix section 410 that includes source code located after an identified security vulnerability. The suffix section 410 works with prefix and middle sections to provide context for vulnerability fixes while preserving code structure and functionality. The guardrail LM uses the suffix section, along with special tokens and the prefix section, to generate targeted fixes while keeping the suffix section unchanged.

One or more embodiments implement a token insertion process 412 segments source code into three sections around an identified vulnerability: a prefix section 406 before the vulnerability, a middle section 408 including the vulnerability, and a suffix section 410 after the vulnerability. The process inserts special tokens like “FILL_HERE” around the middle section to mark where security fixes should be generated. This structured approach enables precise targeting of vulnerabilities while preserving the surrounding code context. The process handles both single-line and multi-line vulnerabilities by using line number ranges from static analysis tools to properly segment the code and insert tokens.

One or more embodiments include an annotated code 414 that divides source code into three sections: a prefix section before the vulnerability, a middle section including the vulnerable code, and a suffix section after the vulnerability. Special tokens (“FILL_PREFIX”, “FILL_HERE”, and “FILL_SUFFIX”) mark these sections, enabling the guardrail LM to generate security fixes for the vulnerable code while preserving the surrounding code structure and context.

One or more embodiments process code through a structured annotation approach to prepare the code for security vulnerability remediation. The system divides the initial source code into three distinct sections based on the location of an identified security vulnerability. A prefix section includes code that appears before the vulnerable code segment. A middle section includes the specific code identified as having the security vulnerability. A suffix section includes code that appears after the vulnerable code segment.

One or more embodiments insert special tokens around the middle section including the vulnerable code to clearly mark where fixes need to be applied. These special tokens serve as markers that help the guardrail LM understand exactly which portion of code needs to be modified. The tokens may include indicators, like “FILL_PREFIX”, “FILL_HERE”, and “FILL_SUFFIX,” to delineate the different code sections.

One or more embodiments pass the annotated code structure to the guardrail LM for processing. The model generates fixes by considering the full context provided by the prefix and suffix sections while focusing specifically on replacing the marked middle section that includes the vulnerability. This approach allows the model to maintain proper code context and structure while generating targeted security fixes.

One or more embodiments preserve the surrounding code structure by keeping the prefix and suffix sections intact. The guardrail LM modifies the specifically marked vulnerable section between the special tokens. This targeted approach helps prevent unintended changes to working code while addressing the security vulnerability.

One or more embodiments enable efficient vulnerability remediation through this structured annotation process. By clearly delineating the code sections and using special tokens to mark vulnerable areas, the system helps the smaller guardrail LM focus specifically on generating appropriate security fixes while maintaining overall code integrity.

### 2.4 Multi-File Vulnerability Remediation System

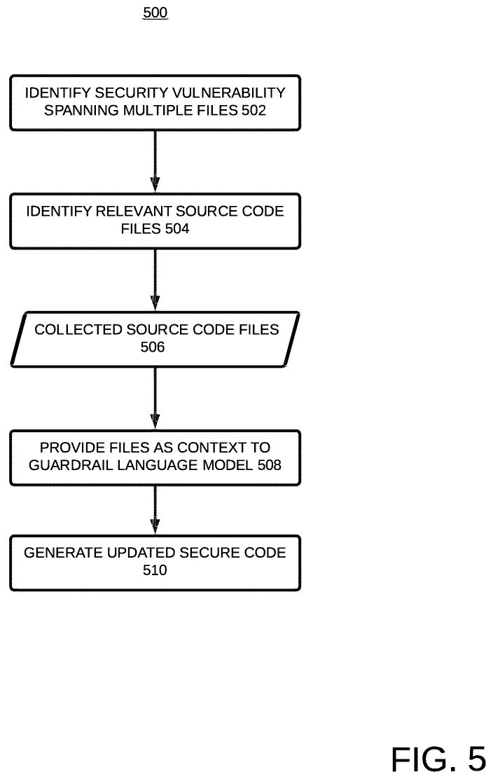

FIG. 5 illustrates a system 500 for identifying and remediating security vulnerabilities spanning multiple files by collecting relevant source code files and providing them to a specialized LM according to one or more embodiments. The system 500 represents an extension of the system 100 of FIG. 1. Unless the context clearly indicates otherwise, the system 500 may be used in conjunction with, or instead of, any other extension of system 100 of FIG. 1 disclosed herein with respect to the other figures.

One or more embodiments handle security vulnerabilities that span across multiple files in a codebase (Operation 502). When analyzing the initial programming language source code, the system identifies programming language source code files that include code relevant to a detected security vulnerability (Operation 504). The system then provides these identified files 506 as contextual information to the security-focused guardrail LM (Operation 508). By providing this broader context, the guardrail LM can generate updated programming language source code that properly addresses security vulnerabilities whose scope extends beyond a single file (Operation 510). This approach enables the guardrail LM to understand the full context of the vulnerability and make appropriate modifications while maintaining the advantage of being smaller in size than the base LM that generated the initial code.

One or more embodiments collect and process multiple related source code files when detecting a security vulnerability that spans file boundaries (Operation 502). The embodiments provide these files to the guardrail LM to enable understanding of cross-file dependencies and interactions creating the vulnerability. The guardrail LM uses this multi-file context to generate coordinated fixes that maintain consistency and properly address security issues involving interactions between different code modules.

One or more embodiments collect source code files including code relevant to multi-file security vulnerabilities (Operation 504). Upon detecting a vulnerability spanning files or modules, the system gathers all pertinent source files to provide context for the guardrail LM. The system processes the related files together, enabling the guardrail LM to understand cross-file dependencies and generate appropriate fixes. By providing the collected files as supplementary context in language model prompts to the guardrail LM, the system enables generation of security fixes that maintain consistency and preserve inter-file dependencies.

One or more embodiments collect source code files 506 when addressing security vulnerabilities that span multiple files or modules. When static analysis identifies cross-file vulnerabilities, the system gathers all relevant source files that include code related to the vulnerability. The guardrail LM processes these files together to understand the vulnerability's full scope and generate consistent fixes across affected components while maintaining system context and existing functionality.

One or more embodiments provide comprehensive context to the guardrail LM when handling vulnerabilities spanning multiple source code files (Operation 508). The system collects and provides relevant source code files affected by or contributing to a vulnerability as contextual input to the guardrail LM during fix generation. This enables the guardrail LM to understand cross-file dependencies and generate coordinated fixes that maintain consistency across file boundaries while preserving code structure. For example, when handling an SQL injection vulnerability involving unsanitized data passing between modules, the system includes both the input handling file and database query file.

One or more embodiments generate updated secure code by applying the guardrail LM that processes annotated code and related source files that include security vulnerabilities (Operation 510). When vulnerabilities span multiple files, the system provides relevant files as context to the guardrail LM, enabling the guardrail LM to understand cross-file dependencies. The guardrail LM, which is smaller and security-focused, generates fixes that address vulnerabilities while maintaining code structure and cross-file consistency.

One or more embodiments handle security vulnerabilities that span across multiple source code files by collecting and processing relevant files together. When the static analysis tool identifies a vulnerability that involves multiple files or modules, the system first identifies the source code files that include code relevant to the security vulnerability. The system then provides these collected files as contextual information to the guardrail LM during the fix generation process. This approach enables the guardrail LM to understand the full context of cross-file dependencies and generate appropriate fixes that address vulnerabilities spanning multiple files. For example, if an SQL injection vulnerability exists due to improper input validation spread across a controller file and a database access file, the system provides both files to the guardrail LM. This allows the guardrail LM to generate coordinated fixes that ensure proper input validation is implemented consistently across affected files. The multi-file context helps the guardrail LM maintain the integrity of inter-file dependencies while fixing the security vulnerability.

### 2.5 Iterative Security Analysis and Remediation Loop

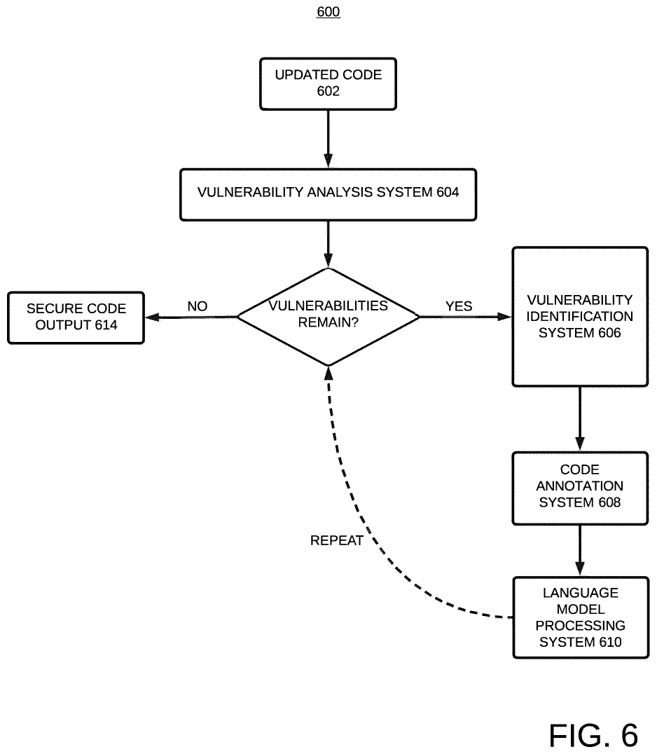

FIG. 6 illustrates a system 600 for iteratively analyzing and remediating security vulnerabilities in programming code through repeated analysis, annotation, and model application according to one or more embodiments. The system 600 represents an extension of the system 100 of FIG. 1. Unless the context clearly indicates otherwise, the system 600 may be used in conjunction with, or instead of, any other extension of system 100 of FIG. 1 disclosed herein with respect to the other figures.

One or more embodiments implement an iterative security improvement process after generating the initial updated programming language source code. The process begins by a vulnerability analysis system 604 analyzing the updated source code 602 to check for any remaining security vulnerabilities. If additional vulnerabilities are found, a vulnerability identification system 606 analyzes the updated code 602 to specifically identify these new vulnerabilities. A code annotation system 608 then annotates the updated source code 602 to mark the locations and types of the newly identified vulnerabilities. A guardrail LM processing system 610 processes this newly annotated code to generate a further updated version that addresses these additional vulnerabilities. This analyze-annotate-improve cycle continues iteratively until security analysis confirms that no vulnerabilities remain in the code. Each iteration preserves the improvements from previous cycles while addressing newly identified or remaining security issues. This iterative approach ensures thorough remediation of security vulnerabilities that may not have been fully addressed in the first pass or that may have complex interdependencies requiring multiple refinement cycles.

One or more embodiments process updated programming language source code 602 through an iterative validation loop. A static analysis tool identifies security vulnerabilities in the code and annotates the security vulnerabilities with special tokens like <FILL-HERE>. The guardrail LM then processes the annotated code to generate fixes for the marked vulnerabilities. This analyze-annotate-fix cycle continues until the static analysis confirms no vulnerabilities remain while preserving the overall code structure by only modifying the marked sections.

One or more embodiments employ a vulnerability analysis system 604 to analyze updated programming language source code through an iterative validation and feedback loop that processes code fixes using static analysis and LM-based remediation. A static analysis scan verifies if vulnerabilities remain in the updated code. For any detected vulnerabilities, the system marks their locations with special tokens. The guardrail LM generates targeted fixes while preserving code structure. The iteration continues until static analysis confirms vulnerabilities have been remediated, providing robust security through efficient use of the guardrail LM rather than a larger general-purpose model.

One or more embodiments implement a vulnerability identification system 606 that analyzes updated source code 602 using static analysis tools to identify remaining vulnerabilities after initial fixes. The vulnerability identification system 606 marks newly identified vulnerabilities with tokens and annotations then feeds the annotated code to the guardrail LM to generate additional fixes. This cycle of detection, annotation, and fixing continues until static analysis confirms no vulnerabilities remain.

One or more embodiments employ a code annotation system 608 to annotate code with identified vulnerabilities using an iterative process. The process begins by analyzing source code with a static analysis tool to identify security vulnerabilities after initial fixes. For newly detected vulnerabilities, special tokens (“FILL_PREFIX”, “FILL_HERE”, “FILL_SUFFIX”) mark the vulnerable code segments, dividing the code segments into prefix, vulnerable, and suffix sections. This annotation format enables the guardrail LM to generate targeted fixes while preserving surrounding code. The process repeats until the static analysis confirms no vulnerabilities remain, ensuring comprehensive security remediation while maintaining code structure.

One or more embodiments apply a guardrail LM 610 iteratively to fix security vulnerabilities in source code. The guardrail LM analyzes code with tokens marking vulnerable segments and generates fixes. After each fix, the system checks for remaining vulnerabilities, annotates any found, and reapplies the guardrail LM. This process continues until no vulnerabilities remain. The guardrail LM maintains efficiency through the guardrail LM's specialized security vulnerability training and smaller size compared to the first code-generating model. The guardrail LM generates targeted fixes while preserving surrounding code structure, avoiding full code regeneration.

One or more embodiments implement an iterative validation and feedback process. The process analyzes updated code for security vulnerabilities, annotates any detected issues, and feeds the annotated code back through the guardrail LM for fixes. This cycle repeats until static analysis confirms no vulnerabilities remain. The smaller, specialized guardrail LM performs these iterations efficiently with low latency while preserving valid code structure from previous iterations.

One or more embodiments process secure code 614 through an iterative validation and feedback loop that performs the following steps until security vulnerabilities are eliminated: 1. Analyzing updated code using static analysis tools to verify fix effectiveness, 2. Identifying any remaining vulnerabilities through additional analysis, 3. Annotating code with special tokens to mark vulnerability locations, and 4. Using a guardrail LM to generate new fixes based on the annotations.

The iterative approach maintains code structure integrity while enabling incremental security improvements through targeted fixes that preserve the surrounding code context.

One or more embodiments implement an iterative security improvement process for programming language source code. After a first pass of security vulnerability detection and remediation, the system analyzes the updated code to check if any security issues remain unresolved. The system performs this analysis using static analysis tools that can identify specific vulnerability types and their locations within the code.

One or more embodiments continue the security improvement process when additional vulnerabilities are found. The system annotates the locations of newly identified vulnerabilities in the updated code using special tokens like <FILL-HERE>. These annotations mark the specific code segments that require further security fixes while preserving the surrounding code context.

One or more embodiments apply the guardrail LM to generate fixes for the newly annotated vulnerabilities. The guardrail LM processes the annotated code to produce targeted fixes that address the remaining security issues. The LM maintains awareness of previous fixes while generating new ones to avoid introducing additional vulnerabilities.

One or more embodiments implement this cycle of analysis, annotation, and fix generation as a loop that continues until the static analysis tool confirms that no security vulnerabilities remain in the code. Each iteration refines the code further, with the guardrail LM generating increasingly secure versions while preserving the original functionality and structure. This iterative approach ensures thorough remediation of identified security issues before the code is considered ready for production use.

One or more embodiments achieve comprehensive security improvements through multiple passes rather than attempting to fix all vulnerabilities in a single iteration. This approach allows the system to handle complex cases where fixing one vulnerability might reveal or require addressing additional security concerns. The process continues until reaching a stable state where no further security issues are detected.

### 2.6 Prioritized Security Vulnerability Training System

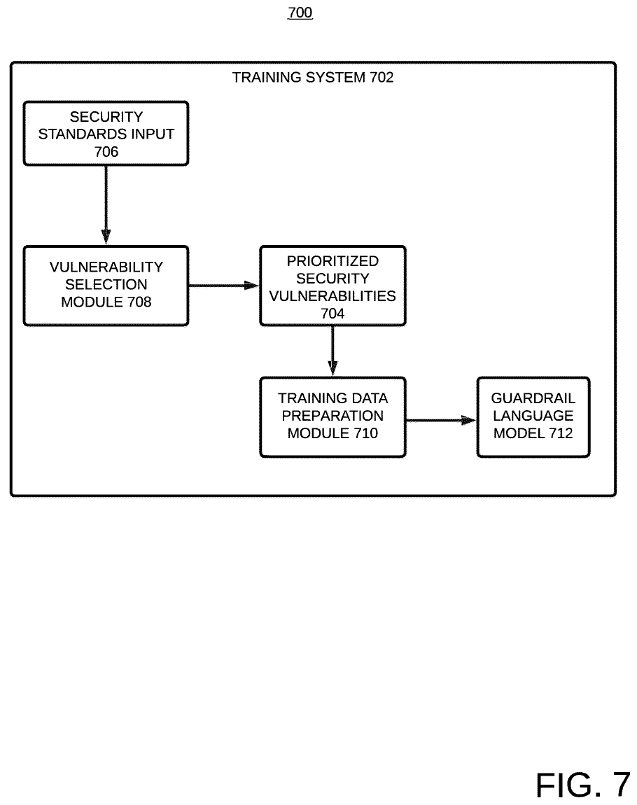

FIG. 7 illustrates a system 700 for training a specialized LM to remediate predetermined prioritized security vulnerabilities based on security standards and organizational requirements according to one or more embodiments. The system 700 represents an extension of the system 100 of FIG. 1. Unless the context clearly indicates otherwise, the system 700 may be used in conjunction with, or instead of, any other extension of system 100 of FIG. 1 disclosed herein with respect to the other figures.

One or more embodiments train the guardrail LM to remediate a predetermined set of prioritized security vulnerabilities. The predetermined set reflects specific security standards or organizational requirements. For example, an organization may prioritize vulnerabilities based on industry security standards, like OWASP Top 10, or compliance requirements like Payment Card Industry Data Security Standard (PCI DSS). The guardrail LM focuses the guardrail LM's training on remediating these specific high-priority vulnerabilities when processing the annotated source code. This targeted training approach allows the guardrail LM to remain smaller than the base LM while effectively addressing the most critical security concerns. When the guardrail LM generates updated programming language source code, the guardrail LM specifically focuses on fixing the identified vulnerabilities that match the predetermined prioritized set while preserving the core functionality from the initial source code.

One or more embodiments encompass a training system 702 that trains a LM using a focused approach for security vulnerability remediation. The training uses prioritized security vulnerabilities from standards, like OWASP Top 25/50, and processes vulnerability datasets from CVE, NVD, and security repositories to create input-output pairs of vulnerable and fixed code.

One or more embodiments structure the training data using special tokens, such as <FILL-HERE>, <fim-prefix>, <fim-suffix>, and <fim-middle>, to mark fix locations. A preprocessing and tokenization pipeline prepares code samples for training, focusing on specific critical vulnerabilities rather than all code issues.

One or more embodiments produce a model of 1-7 billion parameters that efficiently handles vulnerability fixes while minimizing resources. The system maintains synchronization between static analysis rules and training data through periodic (e.g., monthly, yearly) retraining when new vulnerability types emerge.

One or more embodiments include a prioritized vulnerability database 704 that stores security vulnerabilities for training a guardrail LM. The database 704 includes vulnerability definitions and examples based on standards, like OWASP Top 25/50, or organizational requirements. By maintaining a predetermined set of high-priority security issues rather than all possible vulnerabilities, the database 704 enables focused training on critical security concerns. When static analysis identifies vulnerabilities, the guardrail LM uses the guardrail LM's training from this database 704 to generate fixes. The database supports periodic updates as new critical vulnerability types emerge, typically yearly, since major new categories are infrequent.

One or more embodiments employ a security standards input 706 that defines and prioritizes specific security vulnerabilities for a guardrail LM to address. The security standards input focuses on key vulnerabilities, like OWASP Top 25/50, or organization-specific priorities, enabling targeted training on critical security concerns. Organizations can align the model's training with their security requirements by specifying priorities, such as SQL injection or cross-site scripting vulnerabilities. The security standards input 706 also enables model updates when new vulnerabilities appear in databases, like the National Vulnerability Database, maintaining effectiveness for key security remediation tasks.

One or more embodiments include a vulnerability selection module 708 that identifies and processes high-priority security vulnerabilities based on standards, like OWASP Top 25/50, or organization-specific requirements. The vulnerability selection module focuses on critical security concerns rather than all code issues, working with static analysis to match predetermined priorities. This focused approach enables efficient training and reliable remediation by developing expertise in specific vulnerabilities important to the organization. The vulnerability selection module synchronizes static analysis rules with the model's training data and supports updates when new vulnerabilities are added to security databases.

One or more embodiments prepare focused training data for a guardrail LM using a training data preparation module 710. The module filters and processes vulnerability datasets from CVE and NVD to create training pairs targeting high-priority security vulnerabilities from standards like OWASP Top 25/50. A training pair includes vulnerable code and its secure fix, structured with tokens, such as <FILL-HERE>, to mark sections needing remediation. This focused approach enables the model to efficiently address critical security vulnerabilities while maintaining a smaller parameter count.

One or more embodiments employ a guardrail LM 712 that receives specialized training to remediate prioritized security vulnerabilities based on standards, like OWASP Top 25/50, or organizational requirements. This focused approach enables expertise in fixing critical security issues while maintaining a smaller model size compared to general-purpose models. The specialized training helps recognize specific vulnerability patterns and generate fixes that align with security best practices and organizational policies.

One or more embodiments train a specialized guardrail LM to focus on remediating specific, high-priority, security vulnerabilities rather than attempting to address all possible code issues. The guardrail LM targets vulnerabilities from established security standards, like the OWASP Top 25/50 vulnerabilities list, or those identified as critical by an organization's security requirements. This training approach allows the model to develop deeper expertise in fixing the most important security issues rather than spreading the model's capacity across all potential vulnerabilities. The model learns to recognize and remediate patterns associated with these prioritized vulnerabilities through training on selected examples of vulnerable code and their corresponding secure fixes. By limiting the scope to a predetermined set of critical vulnerabilities, the model can achieve higher accuracy and reliability in generating security fixes while maintaining a smaller parameter count compared to general-purpose LMs. Organizations can customize the predetermined set of vulnerabilities based on their specific security needs, industry requirements, or compliance standards. This targeted approach ensures that the most critical security issues receive focused attention and reliable remediation, while other types of code issues may be handled through different processes or tools.

### 2.7 External Dependency Vulnerability Handling System

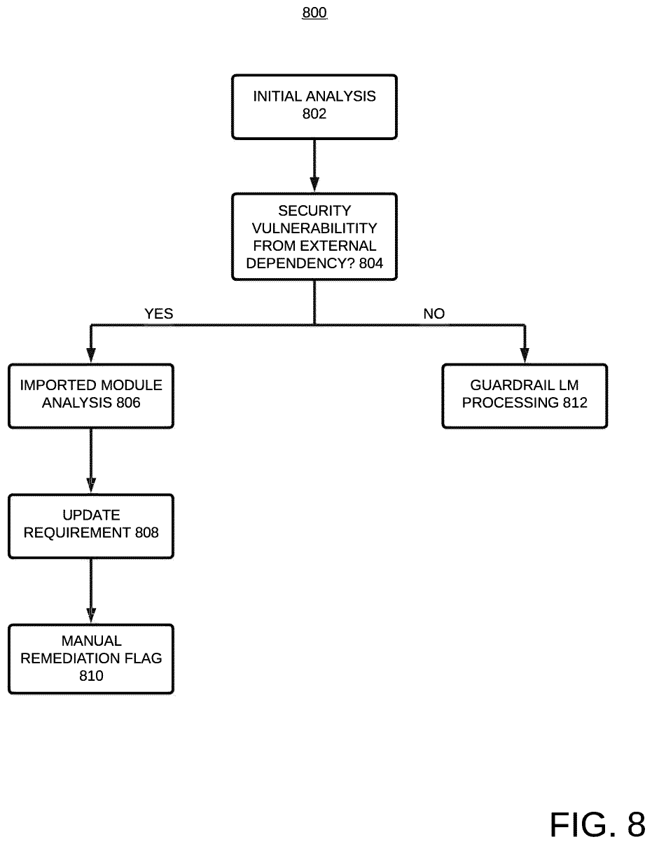

FIG. 8 illustrates a system 800 for analyzing security vulnerabilities in source code and handling external dependency vulnerabilities through manual remediation rather than LM processing according to one or more embodiments. The system 800 represents an extension of the system 100 of FIG. 1. Unless the context clearly indicates otherwise, the system 800 may be used in conjunction with, or instead of, any other extension of system 100 of FIG. 1 disclosed herein with respect to the other figures.

One or more embodiments analyze the initial programming language source code to identify security vulnerabilities that originate from external dependencies, such as imported modules or packages. Upon detecting such a vulnerability, the system determines if the vulnerability requires updating the external dependency or modifying the source code itself. In cases where the vulnerability stems from an external dependency, the system flags these issues for manual remediation instead of attempting automated fixes through the guardrail LM. This approach recognizes that certain security issues, particularly those involving external dependencies, require human intervention and cannot be effectively addressed through automated code modifications. The system makes this determination after analyzing the initial programming language source code generated by the base LM but before applying the guardrail LM for remediation. This selective approach ensures that security vulnerabilities are addressed through the most appropriate channel, either through automated remediation for code-level issues or manual intervention for dependency-related vulnerabilities.

One or more embodiments process code through an initial analysis 802 to identify security vulnerabilities from external dependencies. The analysis examines code generated by the base LM to detect vulnerabilities in imported modules or packages. When identifying security issues from external dependencies, like outdated modules with known vulnerabilities, the system flags the security issues for manual remediation rather than processing the security issues through the guardrail LM. This approach acknowledges that external dependency fixes typically require version updates rather than source code modifications.

One or more embodiments determine to route security vulnerabilities differently based on their source (Operation 804). When vulnerabilities stem from external dependencies, like imported modules or packages, the vulnerabilities are flagged for manual remediation rather than being sent to the guardrail LM for automated fixes. This separation occurs because dependency vulnerabilities typically require version updates or package management changes rather than code modifications. This approach optimizes system resources by directing code-level issues to the automated LM pipeline.

One or more embodiments include an imported module analysis 806 that processes security vulnerabilities from external dependencies in source code. The imported module analysis 806 identifies vulnerabilities from imported modules or packages, distinguishing them from direct code issues. When analyzing source code from a base LM, the imported module analysis 806 determines if vulnerabilities stem from external dependencies such as importing outdated modules with known security flaws. The component flags dependency-related vulnerabilities for manual remediation rather than routing them through a guardrail LM for automated fixes since these issues require version updates rather than code modifications.

One or more embodiments include an update requirement operation 808 that determines if detected security vulnerabilities require external dependency updates or source code modifications. When a static analysis tool identifies vulnerabilities in imported modules or packages, the update requirement operation 808 directs these issues to manual remediation instead of automated fixes through the guardrail LM. This approach handles cases, like outdated module versions, by routing them to a manual update workflow rather than attempting automated code changes.

One or more embodiments employ a manual remediation flag operation 810 that identifies security vulnerabilities requiring human intervention rather than automated fixes, particularly for issues stemming from external dependencies. When static analysis detects security flaws in imported modules or package versions, the manual remediation flag operation 810 marks these for manual handling since version updates and dependency management require human decision making. This selective flagging directs dependency-related security issues to human reviewers while allowing automated systems to address direct code vulnerabilities.

One or more embodiments include a guardrail LM processing operation 812 that applies the guardrail LM to fix the security vulnerability in the case where the security vulnerability was determined not to stem from external dependencies.

One or more embodiments handle security vulnerabilities differently based on their source and required remediation approach. When analyzing initial code generated by a base LM, the system specifically identifies vulnerabilities that stem from external dependencies, such as imported modules or packages. Upon detecting such vulnerabilities, the system determines if the security issue requires updating an external dependency version or modifying the actual source code. For example, if the code imports an older version of a library that includes known security flaws, the system recognizes the security issue as an external dependency issue. The system then flags these dependency-related vulnerabilities for manual remediation instead of attempting to fix the dependency-related vulnerabilities through the guardrail LM. This approach acknowledges that version updates and dependency management require different handling than direct code modifications. The system makes this distinction to ensure appropriate remediation paths-directing external dependency issues to manual review while reserving the guardrail LM for vulnerabilities that can be addressed through code changes. This specialized handling helps maintain the efficiency of the automated fix generation process by focusing the automated fix generation process on vulnerabilities where code modifications can provide effective solutions.

### 2.8 Model Size Comparison Architecture

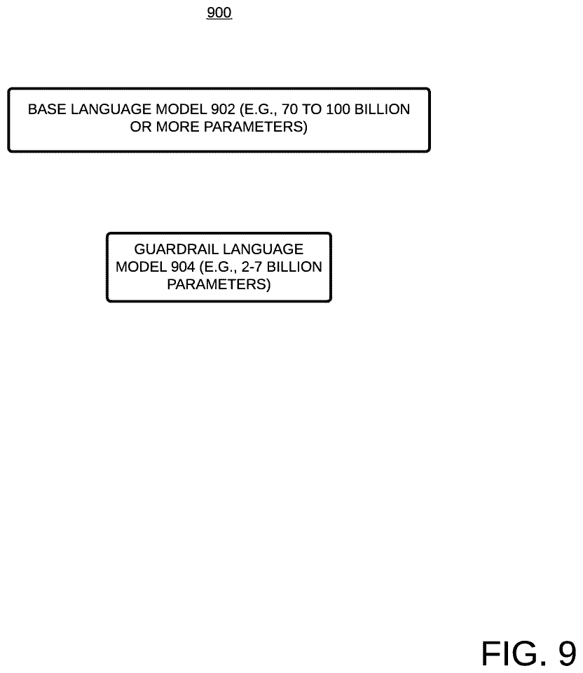

FIG. 9 illustrates a system 900 for comparing a general-purpose LM having a large number of parameters with a specialized security LM having fewer parameters according to one or more embodiments. The system 900 represents an extension of the system 100 of FIG. 1. Unless the context clearly indicates otherwise, the system 900 may be used in conjunction with, or instead of, any other extension of system 100 of FIG. 1 disclosed herein with respect to the other figures.

One or more embodiments employ two distinct LMs with different parameter sizes for code generation and security remediation. A general-purpose base LM generates the initial programming language source code using a larger number of parameters. The base LM's broader parameter space enables the base LM to handle diverse code generation tasks. The guardrail LM, which performs security vulnerability remediation, operates with fewer parameters than the base LM. The reduced parameter count of the guardrail LM reflects the guardrail LM's specialized focus on security improvements rather than general code generation. This architectural choice of using a smaller, specialized model for security remediation helps maintain efficiency while addressing specific security concerns in the code. The guardrail LM processes the annotated code to generate updated code that fixes security issues while preserving portions of the original implementation.

One or more embodiments implement a base LM 902 that generates initial programming language source code from user prompts. This model includes 70-100 billion or more parameters and handles general code generation tasks, including debugging and test case writing. While the model's large parameter count enables sophisticated code generation, the model may introduce security vulnerabilities since the model's training data includes insecure code patterns with studies showing up to 40% of generated code being vulnerable. The model serves as the initial code generation component before security-focused components identify and fix vulnerabilities.

One or more embodiments implement a specialized guardrail LM for security vulnerability remediation that operates with 2-7 billion parameters compared to 70-100 billion or more parameters in the base LM 902. By training on security vulnerability fixes and using special tokens to mark vulnerable code sections, this guardrail model 904 maintains high accuracy while enabling faster processing and lower latency. The focused training on vulnerable/fixed code pairs helps avoid introducing new vulnerabilities that could arise from general pre-training data.

One or more embodiments implement a secure code generation system using two distinct LMs with different parameter sizes optimized for their specific roles. The base LM serves as a general-purpose model with a larger parameter count, enabling the base LM to handle diverse code generation tasks in response to user prompts. The guardrail LM employs a smaller parameter count, specifically focusing on security vulnerability remediation. This size difference reflects the specialized nature of the second model's task compared to the broader capabilities required of the base model.

One or more embodiments utilize a base LM in the range of 70-100 billion or more parameters to provide comprehensive code generation capabilities. This larger model can understand complex user requirements and generate initial code across various programming languages and use cases. The guardrail LM operates with just 1-7 billion parameters, maintaining high accuracy for vulnerability remediation while requiring significantly fewer computational resources.

One or more embodiments achieve improved efficiency through this two-model approach. The guardrail model can generate secure fixes with lower latency compared to repeatedly prompting a larger base model. This architecture provides practical advantages for production deployment while maintaining the ability to generate secure and contextually accurate code modifications.

### 3. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

In one example, a base LM generates initial PYTHON source code for a user authentication function in response to a prompt requesting code for user login functionality. The initial code (with line numbers for reference) includes:
00: def authenticate_user(username, password):
01: #Connect to database
02: db=get_database_connection( )
03: #Check credentials
04: query=f“SELECT * FROM users WHERE username=‘{username}’ AND password=‘{password}’”
05: result=db.execute(query)
06: if result:
07: return True
08: return False

This initial code contains several security vulnerabilities: it uses string formatting in SQL queries making it vulnerable to SQL injection attacks, stores passwords in plain text, and lacks proper input validation. After static analysis identifies the vulnerabilities, the initial code is annotated with special tokens to mark vulnerable sections for the guardrail LM to yield an annotated code (with reference lines numbers) as follows:
00: def authenticate_user(username, password):
01: <fim-prefix>
02: #Connect to database
03: db=get_database_connection( )
04: #Check credentials
05: </fim-prefix>
06: #VULNERABILITY: Uses string formatting in SQL queries making it vulnerable to SQL injection attacks, stores passwords in plain text, and lacks proper input validation.
07: #query=f“SELECT * FROM users WHERE username=‘{username}’ AND password=‘{password}’”
08: #FIXED:
09: <FILL-HERE>
10: <fim-suffix>
11: result=db.execute(query)
12: if result:
13: return True
14: return False
15: </fim-suffix>

The guardrail LM, trained on security vulnerability remediation, processes this annotated code and generates updated programming language source code (with reference lines numbers) as follows:
00: def authenticate_user(username, password):
01: #Connect to database using connection pooling
02: db=get_database_connection( )
03: #Validate inputs
04: #FIXED:
05: if not username or not password:
06: raise ValueError(“Username and password cannot be empty”)
07: #Hash password using secure algorithm
08: password_hash=hash_password(password)
09: #Use parameterized query to prevent SQL injection
10: query=“SELECT * FROM users WHERE username=? AND password_hash=?”
11: result=db.execute(query)
12: if result:
13: return True
14: return False

The updated code addresses the security vulnerabilities while maintaining the core authentication functionality. The updated code introduces parameterized queries to prevent SQL injection, implements password hashing, adds input validation, and uses constant-time comparison to prevent timing attacks. This example demonstrates how the guardrail LM can generate targeted security improvements while preserving the overall structure and purpose of the original code.

### 4. PRACTICAL APPLICATIONS, ADVANTAGES, AND IMPROVEMENTS

One or more embodiments provide practical solutions to the growing challenge of security vulnerabilities in AI-generated code, particularly relevant as organizations increasingly adopt AI coding assistants. These embodiments address a gap in current LM code generation.

One or more embodiments offer significant advantages through a novel, two-part approach combining static analysis with specialized LM-based code remediation. Rather than relying solely on large general-purpose models that may inadvertently learn and reproduce vulnerable code patterns from their training data, these embodiments employ a smaller, specialized LM (e.g., 1-7 billion parameters) trained on security vulnerability datasets. This model can efficiently generate targeted fixes while maintaining code context and structure, resulting in improved performance at lower computational cost.

One or more embodiments provide improvements over existing approaches by implementing an automated pipeline that catches vulnerabilities before deployment and generates contextually appropriate fixes. The use of special tokens and structured code segmentation (prefix, vulnerable section, suffix) allows for modifications without disrupting surrounding code. This approach proves more efficient than traditional methods that might regenerate entire code blocks, while the iterative validation process ensures that generated fixes resolve the identified vulnerabilities. Additionally, these embodiments can handle complex scenarios, including multi-line vulnerabilities and issues spanning multiple files, making them practical for real-world development environments.

One or more embodiments provide particular value in enterprise settings where code security is paramount. By focusing on specific prioritized vulnerabilities (such as OWASP Top 25/50) and maintaining synchronization with current vulnerability databases, these embodiments offer a practical solution for organizations looking to safely incorporate AI-generated code into their development pipeline. The ability to train the system on either internal proprietary code or public vulnerability databases provides flexibility in implementation while maintaining security standards.

### 5. EXAMPLE LANGUAGE MODEL SYSTEMS

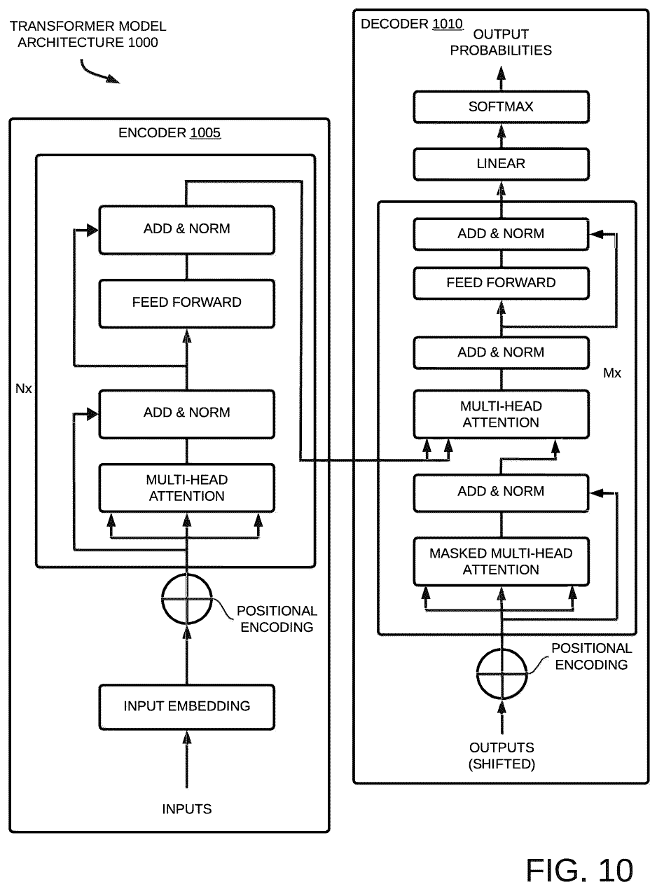

FIG. 10 illustrates an example transformer model architecture 1000 that is used in the implementation of a language model (e.g., a base or guardrail language model) according to one or embodiments of the present disclosure.

The transformer model architecture 1000 is a neural network design for natural language processing. The architecture 1000 encompasses an encoder 1005 and a decoder 1010, both leveraging self-attention mechanisms. The architecture 1000 begins with an input embedding layer that converts tokens into high-dimensional vector representations that range, for example, from 128 to 1024 dimensions. These embeddings are augmented with positional encodings to retain sequence order information.

The transformer model architecture 1000's input embedding layer serves as the initial processing stage for converting discrete tokens into continuous vector representations. These dense embeddings occupy a high-dimensional space, with dimensionality configurations ranging from 128 to 1024, allowing for rich semantic representation of input tokens. The embedding process maps a token to a unique vector that captures the token's semantic properties in the continuous space. Positional encodings are subsequently added to these token embeddings through element-wise addition, introducing position-dependent signals that encode sequential information. These positional encodings are implemented using sinusoidal functions or learned parameters, enabling the model to differentiate between tokens based on their positions in the sequence. The combined embeddings preserve both semantic content and sequential order, forming a foundation for the subsequent self-attention mechanisms. This embedding strategy addresses the inherent limitation of transformer architectures in processing sequential data, as the self-attention mechanism alone is position-agnostic.

The architecture 1000 includes a multi-head, self-attention mechanism. This allows the architecture 1000 to simultaneously attend to different parts of the input sequence, capturing various types of relationships and dependencies. An attention head computes query, key, and value vectors, enabling the model to focus on relevant parts of the input when processing a token. Following the attention layers, the architecture 1000 incorporates feed-forward neural networks with multiple layers and non-linear activation functions.

The multi-head self-attention mechanism forms a component of the transformer architecture 1000, enabling parallel processing of input sequence elements. An attention head operates as an independent attention mechanism, computing three distinct matrices: queries (Q), keys (K), and values (V) through learned linear transformations of the input embeddings. The parallel nature of multiple attention heads allows the model to capture diverse relationship patterns within the same input sequence simultaneously, such as syntactic dependencies, semantic relationships, and long-range contextual connections. The attention computation follows the scaled dot-product attention formula, where the dot product between queries and keys determines alignment scores, followed by scaling and softmax normalization to produce attention weights. These weights are then applied to the value vectors, creating context-aware representations. The feed-forward neural networks following the attention layers include two linear transformations with a non-linear activation function (e.g., ReLU or GELU) between them, processing a position's output independently. This combination of self-attention and position-wise feed-forward networks enables the model to alternate between gathering contextual information across the sequence and applying complex transformations to individual positions, creating a powerful mechanism for sequence processing.

A masked multi-head attention mechanism in the decoder 1010 of a transformer architecture 1000 is designed to prevent the model from attending to future tokens during sequence generation. In this mechanism, multiple attention heads operate in parallel, a computing query (Q), key (K), and value (V) matrices from the input embeddings. The attention scores are calculated as the dot product of Q and K, scaled by the inverse square root of the dimension of the keys. A lower triangular mask is applied to these attention scores before softmax normalization, effectively setting the upper triangular elements to negative infinity. This masking ensures that a position can attend to previous positions in the sequence, maintaining the autoregressive property of the decoder. The masked attention scores are then used to compute a weighted sum of the value vectors. The outputs from the heads are concatenated and linearly transformed to produce the attention output. This process allows the decoder to generate tokens sequentially while considering the previously generated tokens, thus preserving the causal nature of language modeling.

The masked multi-head attention mechanism in the transformer's decoder 1010 implements causal masking to enforce autoregressive generation during sequence processing. An attention head performs linear projections to create query (Q), key (K), and value (V) matrices from input embeddings through learned weight matrices WQ, WK, and WV respectively. The attention computation follows the formula Attention (Q, K, V)=softmax (QK^{T}/√dk)V, where dk represents the dimensionality of the key vectors. A lower triangular mask matrix gets added to the attention scores before softmax normalization. This mask sets all upper triangular elements to negative infinity (−∞), effectively zeroing out these positions after the softmax operation. The masking operation ensures strict causality by preventing any position from attending to future positions in the sequence during both training and inference. Following the masked attention computation, the outputs from multiple attention heads are concatenated along the feature dimension and projected through a final linear transformation WO to produce the layer's output. This output maintains the temporal causality required for autoregressive generation while still allowing a position to attend to all previous positions in the sequence. The parallelized implementation of multiple attention heads enables the model to capture various aspects of the sequence history simultaneously, while the masking mechanism maintains the sequential nature of language generation.

To maintain stable training and mitigate vanishing gradients, the architecture 1000 employs layer normalization after a sub-layer (self-attention and feed-forward networks) and introduces residual connections. These residual connections allow unimpeded information flow through the network. The model includes multiple (Nx) encoder and decoder (Mx) layers stacked on top of each other, increasing its capacity to learn complex language patterns.

The transformer architecture incorporates stabilization techniques through layer normalization and residual connections. Layer normalization is applied after both the self-attention and feed-forward network sub-layers, normalizing the activations across the feature dimension for a token position. The normalization process computes the mean and variance of the features, then scales and shifts the normalized values using learned parameters gamma and beta, effectively standardizing the feature distributions throughout the network. Residual connections, implemented as skip connections, add the input of a sub-layer to the transformed output, creating direct paths for gradient flow during backpropagation. The combination of these components follows the formula LayerNorm(x+Sublayer(x)), where x represents the input and Sublayer represents either the self-attention or feed-forward network.

The stacking of multiple encoder and decoder layers increases the model's capacity logarithmically with respect to sequence length, enabling the capture of hierarchical patterns in language. An additional layer in the stack provides an opportunity for more abstract feature representation, with lower layers capturing local patterns and higher layers learning more complex, global dependencies. The interaction between layer normalization and residual connections creates a well-conditioned optimization landscape, facilitating stable training of deep transformer networks while mitigating the vanishing gradient problem that commonly affects deep neural architectures.

The output layer involves a linear transformation followed by a softmax function, producing probability distributions over the vocabulary for text generation tasks. This architecture 1000's design allows for efficient parallel processing of input sequences, making it particularly suitable for handling the extensive datasets used in training language models.

The output layer of the transformer architecture implements a vocabulary-sized classification mechanism through a linear transformation followed by softmax activation. The linear transformation projects the decoder's hidden states onto a vocabulary-sized space using a weight matrix W∈ [symbol] \hat{ }(d_model×|V|), where d_model represents the model's hidden dimension and |V| represents the vocabulary size. The subsequent softmax function normalizes these log its into a proper probability distribution across the entire vocabulary, computing P(token_i)=exp(z_i)/Σ_j exp(z_j), where z_i represents the log it for the i-th vocabulary token. This architectural design enables efficient batch processing of input sequences through matrix multiplications, leveraging modern hardware accelerators like GPUs and TPUs. The parallel computation capability stems from the self-attention mechanism's ability to process all sequence positions simultaneously during the forward pass, requiring O(1) sequential operations compared to the O(n) operations needed in recurrent architectures. The model's parallelization efficiency scales particularly well with increasing sequence lengths, making the architecture advantageous for processing the extensive datasets used in large language model training, that often include billions of tokens across diverse domains and languages.

In one or more embodiments, architectural variations enhance or modify the standard transformer design for language model implementations. The sparse transformer introduces structured sparsity patterns in the attention mechanism, reducing the quadratic memory complexity to linear complexity through fixed attention patterns. This modification enables processing of much longer sequences while maintaining model quality. Reformer architectures employ locality-sensitive hashing for attention computation, approximating full attention while significantly reducing memory requirements. The performer architecture replaces the attention mechanism with kernel-based formulations using random feature decomposition, achieving linear complexity in both compute and memory.

Alternate positional encoding schemes offer various trade-offs. Rotary Positional Embeddings (RoPE) inject positional information through rotation matrices applied to token embeddings, providing better relative position modeling. ALiBi (Attention with Linear Biases) position embeddings add learned bias terms to attention scores, enabling better extrapolation to sequences longer than those seen during training. Some architectures eliminate explicit positional encodings entirely, instead relying on position-aware linear attention mechanisms.

Architecture modifications also target specific computational bottlenecks. Flash attention optimizes attention computation through careful management of GPU memory access patterns. Mixture of Experts (MoE) architectures incorporate sub-networks activated based on input patterns, increasing model capacity without proportional computation increases. The GLU (Gated Linear Unit) variants replace standard feed-forward networks with gated mechanisms, providing more flexible function approximation. Multi-query attention reduces memory bandwidth requirements by sharing key and value projections across attention heads while maintaining separate query projections.

Some architectures focus on improved training dynamics. The “DeepNorm” normalization strategy modifies the layer normalization scheme to enable stable training of deeper networks. Gradient checkpointing strategies reduce memory requirements during training by recomputing certain activations during backpropagation. State space models offer an alternative to attention mechanisms entirely, using linear state space equations to model sequence relationships with improved computational efficiency.

Alternative architectures for language model implementation encompass distinct paradigms beyond transformers. Recurrent Neural Networks (RNNs), particularly variants like Long Short-Term Memory (LSTM) networks and Gated Recurrent Units (GRUs), process sequences sequentially through hidden state updates. These architectures maintain explicit temporal dependencies through gating mechanisms, controlling information flow between timesteps. LSTM networks employ three gates—input, forget, and output—along with a memory cell to regulate information persistence. GRUs simplify this structure with reset and update gates while maintaining comparable performance.

Convolutional Neural Networks (CNNs) offer another approach through hierarchical feature extraction. Temporal Convolutional Networks (TCNs) apply dilated convolutions to capture long-range dependencies while maintaining autoregressive properties. The hierarchical structure of TCNs enables parallel processing within a layer while preserving causal relationships. Quasi-Recurrent Neural Networks (QRNNs) combine convolutional and recurrent approaches, using convolution for parallel feature extraction followed by a lightweight recurrent pooling mechanism.

Memory-augmented architectures present another paradigm. Neural Turing Machines (NTMs) and Differentiable Neural Computers (DNCs) supplement neural processing with external memory arrays, accessed through attention-like mechanisms. These architectures separate computation from memory storage, enabling more explicit modeling of long-term dependencies. Memory networks similarly incorporate dedicated memory components but with more structured addressing mechanisms.

Continuous-time models offer an alternative perspective on sequence processing. Neural Ordinary Differential Equations (Neural ODEs) model sequence evolution as a continuous-time dynamical system, solving differential equations to process inputs. This approach enables variable timestep processing and potentially more natural handling of temporal relationships. Similarly, Neural Controlled Differential Equations (Neural CDEs) extend this framework to handle irregular time series data while maintaining end-to-end differentiability.

Graph Neural Networks (GNNs) provide yet another alternative by modeling sequences as structured graphs. This approach enables explicit modeling of hierarchical relationships and long-range dependencies through message passing between nodes. Graph-based architectures capture complex dependencies that are difficult to model with purely sequential approaches, though these architectures require careful design of graph structure and update rules.

In one or more embodiments, the transformer-based language model architecture 1000 is not deployed in isolation but rather serves as a module within an overall reasoning framework. In these systems, the language model is integrated into a multi-stage reasoning pipeline that combines the raw generative capabilities of the transformer with additional processes aimed at structured, step-by-step reasoning.

In such a reasoning framework, the language model may be tasked with generating intermediate representations or “chain-of-thought” outputs. These outputs detail intermediate reasoning steps that help decompose complex queries into manageable sub-tasks. For example, the language model may generate an initial hypothesis or a series of candidate reasoning steps, which are then validated by auxiliary modules responsible for consistency checks, fact verification, or domain-specific reasoning rules. This design enables the system to not only generate fluent natural language responses but also to provide transparency into the reasoning process underlying each response.

Moreover, reasoning architectures may incorporate a controller or supervisory module that orchestrates interactions between the language model and other specialized reasoning components. This controller can guide the selection of reasoning paths, manage iterative refinement (e.g., revising or expanding upon earlier generated steps), and leverage external knowledge bases or memory stores to enhance the overall reasoning performance. In one or more embodiments, additional layers of analysis—such as external search mechanisms or multi-hop reasoning strategies—further empower the system to tackle more complex, context-dependent tasks while ensuring that the output remains coherent and logically sound.

By embedding the language model within a larger reasoning ecosystem, one or more embodiments overcome some of the limitations inherent in standalone transformer architectures, such as the lack of explicit intermediate reasoning steps. The integration fosters a symbiotic relationship where the language model's strength in pattern recognition and language generation complements dedicated reasoning and verification processes. As a result, the overall system is capable of improved decision-making, enhanced problem solving, and more robust handling of tasks that require deep and structured reasoning.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In one or more embodiments, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In one or more embodiments, a computer network provides connectivity between clients and network resources. Network resources include hardware and/or software configured to execute server processes. Examples of network resources include a processor, data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to a request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. Custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In one or more embodiments, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In one or more embodiments, a tenant is associated with a tenant ID. An network resource of the multi-tenant computer network is tagged with a tenant ID. A tenant is permitted access to a particular network resource if the tenant and the particular network resources are associated with a same tenant ID.

In one or more embodiments, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset if the tenant and the particular application, data structure, and/or dataset are associated with a same tenant ID.

As an example, a database implemented by a multi-tenant computer network may be tagged with a tenant ID. Only a tenant associated with the corresponding tenant ID may access data of a particular database. As another example, a entry in a database implemented by a multi-tenant computer network may be tagged with a tenant ID. Only a tenant associated with the corresponding tenant ID may access data of a particular entry. However, the database may be shared by multiple tenants.

In one or more embodiments, a subscription list indicates that tenants have authorization to access that applications. For an application, a list of tenant IDs of tenants authorized to access the application is stored. A tenant is permitted access to a particular application if the tenant ID of the tenant is included in the subscription list corresponding to the particular application.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

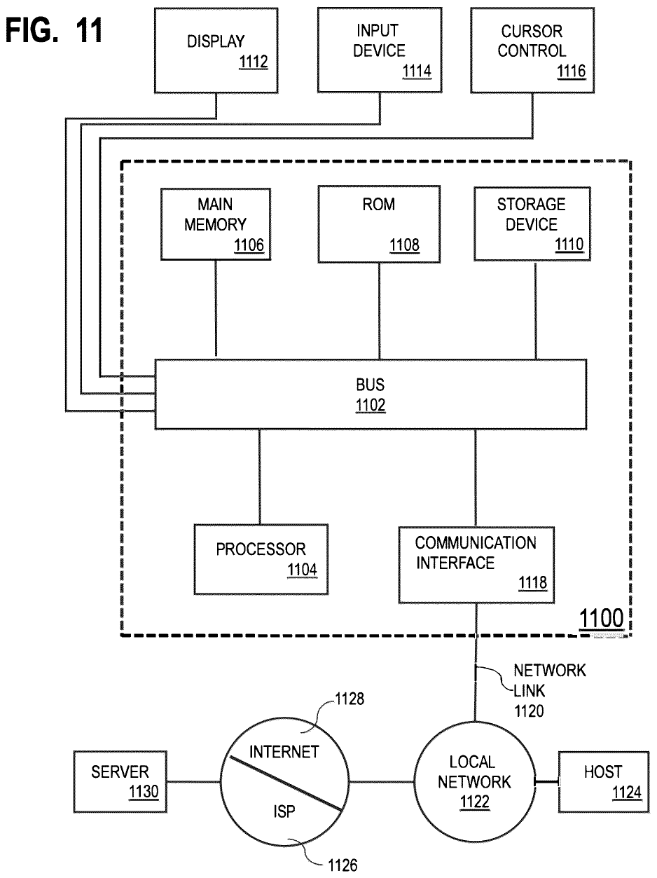

FIG. 11 is a block diagram that illustrates an example computer system 1100 upon which one or more embodiments are implemented. Computer system 1100 includes a bus 1102 or other communication mechanism for communicating information, and a hardware processor 1104 coupled with bus 1102 for processing information. Hardware processor 1104 may be, for example, a general-purpose microprocessor.

Computer system 1100 also includes a main memory 1106, such as a random-access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or a Solid-State Drive (SSD) is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic that in combination with the computer system causes or programs computer system 1100 to be a special-purpose machine. According to one embodiment, the techniques herein are performed by computer system 1100 based on processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from that processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, that carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner that might adversely affect their validity as trademarks.

Embodiments are directed to a system with one or more devices that include a hardware processor and that are configured to perform any of the operations described herein and/or recited in any of the claims below.

In one or more embodiments, one or more non-transitory computer readable storage media comprises instructions that, when executed by one or more hardware processors, cause performance of any of the operations described herein and/or recited in any of the claims.

In one or more embodiments, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in that such claims issue, including any subsequent correction.

What is claimed is:

1. A method comprising:
obtaining initial programming language source code that is generated by a first language model;
analyzing the initial programming language source code to identify one or more security vulnerabilities in the initial programming language source code;
annotating the initial programming language source code to yield annotated programming language source code that indicates the one or more security vulnerabilities; and
applying a second language model to the annotated programming language source code to generate an updated programming language source code that addresses the one or more security vulnerabilities and retains at least a portion of the initial programming language source code, wherein the second language model is trained for security vulnerability remediation and is smaller in size than the first language model.

2. The method of claim 1, wherein analyzing the initial programming language source code to identify the one or more security vulnerabilities is based on at least:
analyzing the initial programming language source code using a static analysis tool to identify one or more portions of the initial programming language source code comprising the one or more security vulnerabilities and corresponding vulnerability types; and
generating a structured output comprising identifiers of the one or more portions and the corresponding vulnerability types, wherein the annotating is based on the structured output.

3. The method of claim 1, wherein the second language model being trained for security vulnerability remediation is based on at least the second language model being trained using training pairs of programming language source code, wherein each training pair comprises an original programming language source code version comprising a security vulnerability and a corrected programming language source code version with the security vulnerability remediated.

4. The method of claim 1, wherein:
the annotating is based on at least dividing the initial programming language source code into a prefix section comprising programming language source code before a security vulnerability of the one or more security vulnerabilities, a middle section comprising the security vulnerability, and a suffix section comprising programming language source code after the security vulnerability;
the annotating is based on at least inserting one or more special tokens to mark the middle section to yield the annotated programming language source code; and
applying the second language model is based on at least generating the updated programming language source code based on the prefix section, the one or more special tokens, and the suffix section.

5. The method of claim 1, wherein a security vulnerability of the one or more security vulnerabilities spans multiple files; wherein the method further comprises identifying programming language source code files comprising programming language source code relevant to the security vulnerability; and wherein applying the second language model is based on at least providing the identified programming language source code files as context to the second language model when generating the updated programming language source code.

6. The method of claim 1, further comprising:
analyzing the updated programming language source code to determine if additional security vulnerabilities remain;
upon determining that additional security vulnerabilities remain:
analyzing the updated programming language source code to identify the additional security vulnerabilities;
annotating the updated programming language source code to indicate the additional security vulnerabilities;
applying the second language model to the annotated updated programming language source code to generate a further updated programming language source code; and
repeating the analyzing, annotating, and applying until no security vulnerabilities remain in the further updated programming language source code.

7. The method of claim 1, wherein the second language model being trained for security vulnerability remediation is based on at least the second language model being trained to remediate a predetermined set of prioritized security vulnerabilities, wherein the predetermined set is based on security standards or organizational requirements.

8. The method of claim 1, wherein analyzing the initial programming language source code identifies that a security vulnerability, of the one or more security vulnerabilities, stems from an external dependency; and wherein the method further comprises:
determining that the security vulnerability is associated with an imported module or package;
determining that the security vulnerability requires updating the external dependency rather than modifying the initial programming language source code; and
flagging the security vulnerability for manual remediation instead of applying the second language model.

9. The method of claim 1, wherein:
the first language model comprises a general-purpose language model having a first number of parameters; and
the second language model being smaller in size than the first language model comprises the second language model having a second number of parameters that is less than the first number of parameters.

10. The method of claim 9, wherein the second number of parameters is between 1% and 10% of the first number of parameters.

11. One or more non-transitory computer-readable media storing a set of instructions which, when executed by a set of one or more processors, cause a set of one or more computer systems to perform a set of operations comprising:
obtaining an initial programming language source code that is generated by a first language model;
analyzing the initial programming language source code to identify one or more security vulnerabilities in the initial programming language source code;
wherein analyzing the initial programming language source code to identify the one or more security vulnerabilities is based on at least:
analyzing the initial programming language source code using a static analysis tool to identify one or more portions of the initial programming language source code comprising the one or more security vulnerabilities and corresponding vulnerability types, and
generating a structured output comprising identifiers of the one or more portions and the corresponding vulnerability types;
annotating, based on at least the structured output, the initial programming language source code to yield annotated programming language source code that indicates the one or more security vulnerabilities; and
applying a second language model to the annotated programming language source code to generate an updated programming language source code that addresses the one or more security vulnerabilities and retains at least a portion of the initial programming language source code, wherein the second language model is trained for security vulnerability remediation and is smaller in size than the first language model.

12. The one or more non-transitory computer-readable media of claim 11, wherein the second language model being trained for security vulnerability remediation comprises the second language model being trained using training pairs of programming language source code, wherein each training pair comprises an original programming language source code version comprising a security vulnerability and a corrected programming language source code version with the security vulnerability remediated.

13. The one or more non-transitory computer-readable media of claim 11, the set of operations further comprising:
dividing the initial programming language source code into a prefix section comprising programming language source code before a security vulnerability of the one or more security vulnerabilities, a middle section comprising the security vulnerability, and a suffix section comprising programming language source code after the security vulnerability;
inserting one or more special tokens to mark the middle section to yield the annotated programming language source code; and
generating the updated programming language source code based on the prefix section, the one or more special tokens, and the suffix section.

14. The one or more non-transitory computer-readable media of claim 11, wherein a security vulnerability of the one or more security vulnerabilities spans multiple files; wherein the set of operations further comprises identifying programming language source code files comprising programming language source code relevant to the security vulnerability; and wherein applying the second language model is based on at least providing the identified programming language source code files as context to the second language model when generating the updated programming language source code.

15. The one or more non-transitory computer-readable media of claim 11, the set of operations further comprising:
analyzing the updated programming language source code to determine if additional security vulnerabilities remain;
upon determining that additional security vulnerabilities remain:
analyzing the updated programming language source code to identify the additional security vulnerabilities;
annotating the updated programming language source code to indicate the additional security vulnerabilities;
applying the second language model to the annotated updated programming language source code to generate a further updated programming language source code; and
repeating the analyzing, annotating, and applying until no security vulnerabilities remain in the further updated programming language source code.

16. A system comprising:
one or more computer systems having one or more hardware processors; and
instructions which, when executed, cause the one or more computer systems to perform a set of operations comprising:
obtaining an initial programming language source code that is generated by a first language model;
analyzing the initial programming language source code to identify one or more security vulnerabilities in the initial programming language source code;
wherein analyzing the initial programming language source code to identify the one or more security vulnerabilities is based on at least:
analyzing the initial programming language source code using a static analysis tool to identify one or more portions of the initial programming language source code comprising the one or more security vulnerabilities and corresponding vulnerability types, and
generating a structured output comprising identifiers of the one or more portions and the corresponding vulnerability types;
annotating, based on at least the structured output, the initial programming language source code to yield annotated programming language source code that indicates the one or more security vulnerabilities; and
applying a second language model to the annotated programming language source code to generate an updated programming language source code that addresses the one or more security vulnerabilities and retains at least a portion of the initial programming language source code, wherein the second language model is trained for security vulnerability remediation and is smaller in size than the first language model.

17. The system of claim 16, wherein the second language model being trained for security vulnerability remediation comprises the second language model being trained using training pairs of programming language source code, wherein each training pair comprises an original programming language source code version comprising a security vulnerability and a corrected programming language source code version with the security vulnerability remediated.

18. The system of claim 16, the set of operations further comprising:
dividing the initial programming language source code into a prefix section comprising programming language source code before a security vulnerability of the one or more security vulnerabilities, a middle section comprising the security vulnerability, and a suffix section comprising programming language source code after the security vulnerability;
inserting one or more special tokens to mark the middle section to yield the annotated programming language source code; and
generating the updated programming language source code based on the prefix section, the one or more special tokens, and the suffix section.

19. The system of claim 16, wherein a security vulnerability of the one or more security vulnerabilities spans multiple files; wherein the set of operations further comprises identifying programming language source code files comprising programming language source code relevant to the security vulnerability; and wherein applying the second language model is based on at least providing the identified programming language source code files as context to the second language model when generating the updated programming language source code.

20. The system of claim 16, the set of operations further comprising:
analyzing the updated programming language source code to determine if additional security vulnerabilities remain;
upon determining that additional security vulnerabilities remain:
analyzing the updated programming language source code to identify the additional security vulnerabilities;
annotating the updated programming language source code to indicate the additional security vulnerabilities;
applying the second language model to the annotated updated programming language source code to generate a further updated programming language source code; and
repeating the analyzing, annotating, and applying until no security vulnerabilities remain in the further updated programming language source code.
